(19) United States
(12) Patent Application Publication
(10) Pub. No.: US 2025/0018284 A1
(43) Pub. Date: Jan. 16, 2025

(54) WHEEL STAND

(71) Applicant: Arnoud Rogier Landzaat, Amsterdam (NL)

(72) Inventor: Arnoud Rogier Landzaat, Amsterdam (NL)

(21) Appl. No.: 18/708,659

(22) PCT Filed: Nov. 9, 2022
(86) PCT No.: PCT/NL2022/050634

§ 371 Date: May 9, 2024

(30) Foreign Application Priority Data
Nov. 9, 2021 (NL) 2029684

(51) Int. Cl. A63F 13/245; A63F 13/803; A63F 13/98

(52) U.S. Cl. CPC A63F 13/245; A63F 13/803; A63F 13/98

(57) ABSTRACT

A wheel stand is provided comprising a housing with a storage volume therein and a top opening allowing access into the storage volume. The wheel stand further comprises a wheel mount moveably attached to the housing, such that the wheel mount can be moved relative to the housing between a storage position and a use position, wherein, in the storage position, the wheel mount is positioned inside the storage volume of the housing, and in the use position, the wheel mount is at least partially positioned outside the storage volume of the housing. By virtue of the housing, when not in use, the wheel stand may be used as and look like a piece of furniture, such as a coffee table.

### TECHNICAL FIELD

The aspects and embodiments thereof relate to the field of wheel stands for mounting controllers such as racing wheels and pedals to.

### BACKGROUND

Racing simulation games can be played on a variety of platforms, such as computers and gaming consoles. To make the racing experience more realistic, instead of using a conventional game controller, keyboard or mouse, more realistic controllers such as simulator wheels, gear shifters, and/or pedals may be used. To position the wheels, gear shifters, and/or pedals in a realistic and ergonomic position, a wheel stand may be used. A wheel stand typically comprises a frame on which wheels, gear shifters, and/or pedals can be mounted, and the frame may be adjustable to accommodate differently sized users.

Wheel stands may further be provided with a chair, the shape of which may mimic that of a race car, to form a racing cockpit, as for example disclosed in WO2009062221A1. To decrease the amount of space occupied by a racing cockpit or wheel stand when not in use, parts of the racing cockpit or wheel stand may be foldable or the chair may be removable.

### SUMMARY

It is preferred to provide for a wheel stand which is convenient to store, and/or which is aesthetically more preferred when not in use and/or which provides further functionalities when not in use. In general, whenever the term wheel stand is used herein, the skilled person will understand such a wheel stand may also be suitable as a flight stand—for example for use as a flight simulator.

A first aspect provides a wheel stand, which for example may be used to form a race simulator rig. The wheel stand comprises a housing with a storage volume therein and a top opening allowing access into the storage volume. The wheel stand further comprises a wheel mount moveably attached to the housing, such that the wheel mount can be moved relative to the housing between a storage position and a use position, wherein, in the storage position, the wheel mount is positioned inside the storage volume of the housing, and in the use position, the wheel mount is at least partially positioned outside the storage volume of the housing.

Because in the storage position, the wheel mount in positioned inside the storage volume of the housing, the size of the wheel stand is reduced compared to the size of the wheel stand when the wheel mount is in the use position of the wheel mount.

A wheel mount is any surface, body, or object, to which a controller may be mounted. A controller may be mounted for example using one or more screws, bolts, nuts, a clamped connection, or any other connection which is preferably releasable.

As an option, the wheel stand may comprise a lid for covering the top opening, in particular when the wheel mount is in the storage position. Alternatively, a kit of parts may be provided comprising an embodiment of the wheel stand and a lid for covering the top opening.

During use—i.e. when the wheel mount is in the use position—the lid may be removed or moved away. The lid may be attachable to the housing, attached to the housing, or provided separately from the housing. When the lid is attached to the housing, for example, the lid may be attached to the housing via one or more hinges. Alternatively, the lid may be slid into one or more grooves of the housing. The lid may be provided with a raised edge, for example to prevent objects from sliding off the lid.

When the wheel stand is not in use, the lid may be used as a useful surface, for example for positioning one or more objects or persons on. As such, the wheel stand has an additional functionality as table, coffee table, decorative object, bench-seat, plant stand or other type of furniture. The lid may provide a substantially flat surface.

When the wheel mount is moved between the storage position and the use position, at least part of the wheel mount may pass through the top opening. In general, the wheel mount may be moved by a user, and/or by one or more actuators comprised by the wheel mount. For example, one or more electric or pneumatic actuators may be used to automatically move the wheel mount between the storage position and the use position.

Embodiments of the housing may comprise a bottom and a plurality of side walls extending substantially perpendicular to the bottom. In use, the bottom may be orientated substantially horizontal, and the side walls may be oriented substantially parallel to gravity. The bottom and the side walls may for example be formed by sheet material, such as sheet metal. Embodiments of the housing without a bottom are also envisioned.

When two of the side walls are oriented substantially parallel, the housing may be positioned in two orientations: 1) with the bottom on a floor or other supporting surface, and 2) with one of the two substantially parallel side walls on the floor or other supporting surface. The second of the two substantially parallel side walls may in the second orientation be oriented parallel to the floor or other supporting surface, and may hence be used to place objects on. It will be understood that the housing may be supported on a floor via one or more legs or feet, in one or more of the possible orientations.

For example, a user may place one or more decorative items on the second of the two substantially parallel side walls. As an option, an additional support surface such as a tray may be positioned between the side wall and the one or more decorative items. As such, the wheel stand, when not in use, may have an additional functionality as pedestal or table. From the outside, it may not be directly apparent that the wheel stand is a wheel stand, which may be preferred by consumers who do not want a visible wheel stand present in their house, in particular in the living room, when the wheel stand is not in use.

The housing may be substantially rigid, in order to be able to support the lid and objects placed on the lid or on other parts of the housing in further optional orientations. As such, the housing may for example comprise rigid materials such as metal, in particular aluminum or steel, wood, rigid polymer, any other rigid material, or any combination thereof.

The housing may be rectangular shaped. Hence, different adjacent side walls may have different dimensions, while opposite side walls may have substantially the same dimensions. Other shapes for the housing are envisioned as well, for example comprising one or more rounded or curved side walls.

Apart from the top opening, the housing or the side walls of the housing may be closed—i.e. devoid of holes or passages through which the contents inside the storage volume are visible from the outside. As such, when not in use, the wheel stand may not appear to be a wheel stand to the outside but may instead appear to be furniture, such as a coffee table, plantstand, cabinet, bench-seat or sideboard. To form a bench-seat, for example, one or more pillows or cushions may be provided, which are sized corresponding to a size of the housing.

In embodiments, the wheel mount may comprise a mounting member, such as a mounting plate at a distal end of the wheel mount. The distal end of the wheel mount is to be understood as the end of the wheel mount which in the use position is positioned away from the housing, in particular away from the bottom of the housing when the housing comprises a bottom. In the use position of the wheel mount, the mounting member may be positioned outside the housing. The mounting member is arranged for having one or more controllers, such as steering wheels, joysticks, and/or shifters, mounted thereon. The mounting member may be formed as a flat plate, curved body, or any other shape of body.

Embodiments of the wheel stand are envisioned comprising a racing wheel controller mounted to the mounting member. In particular, in the storage position, the racing wheel controller may be positioned inside the housing, and in the use position, the racing wheel controller may be fully positioned outside the housing.

As an even further option, which may be combined with any embodiment of the wheel stand, the racing wheel controller at least partially extends beyond the housing, when regarded in a side view and/or top plan view. As such, at least part of the racing wheel controller may be positioned hovering or floating above a seat adjacent to which the wheel stand is positioned.

A second aspect provides a wheel stand, comprising a frame and a wheel mount. The wheel mount is moveably connected to the frame, such that the wheel mount can be moved relative to the frame between a storage position and a use position. From the storage position to the use position, the wheel mount may at least be hinged away from the frame. When the wheel stand does not comprise a housing, the frame may be positioned on the floor or any other support surface.

When the wheel stand comprises a housing, the frame may be connected to the housing or formed by part of the housing. Furthermore, when the wheel stand comprises a housing, the frame may be positioned inside the storage volume-preferably the entire frame is positioned inside the storage volume. The frame may comprise different connected parts, or may substantially be formed as one monolithic frame, for example from plate material.

As a particular option, the frame may comprise two frame guides at opposite sides of the frame, and the wheel mount may at least partially be positioned between the frame guides. Between the frame guides of the frame, there may be an opening in which a user may position part of one or both legs, for example to allow access to one or more pedals. In particular, the mounting member may be positioned between the guide plates of the frame. When for example a steering wheel is mounted to the mounting member, the steering wheel may as such be positioned above the legs or lap of the user, resembling a typical position of a steering wheel. As a particular option, a frame guide may be substantially flat, and may hence be embodied as a guide plate. Instead of being substantially flat or similar to a plate, a frame guide may for example be or comprise one or more rods, cylinders, or any other shape of body.

As an alternative to the frame guides at opposite sides of the frame, a central frame member may be used to attach the wheel mount to. In use, a user may place their legs one on either side of the central frame member. As such, part of the frame and/or part of the wheel mount may in use be positioned between the legs of the user.

When the wheel mount comprises a mounting member, such as a mounting plate, the mounting member may be positioned between two carrying members comprised by the wheel mount, and each carrying member may be moveably connected to a respective one of the frame guides. A carrying member may for example be embodied as a carrying plate, which may be substantially flat. Alternatively, a carrying member may for example be a rod, cylinder, or other shape of body.

In general, two elements being moveably connected means that at least one degree of freedom between the two elements is fixed, and at least one degree of freedom between the two elements is unconstrained, thus allowing movement between the two elements. A movement may be a translation, rotation, or combination thereof, over respectively one or more translation axes and one or more rotation axes.

As a particular option, the frame guides may both comprise a rear guide and a front guide, the wheel stand comprises four guiding members, each coupled to one of the rear guide and the front guide of one of the frame guides, and when moving the wheel stand relative to the frame, the guiding members are guided through their respective one of the rear guide and the front guide. By virtue of the front guide and the rear guide, the trajectory of movement of the wheel mount relative to the frame may be defined.

One of the rear guide and the front guide may comprise two adjacent guide sections, of which a first guide section is a curved guide section, and a second guide section is a substantially straight guide section. In general, a curved guide section may allow a change in orientation of the wheel mount relative to the frame, and a straight guide section may allow a change in position of the wheel mount relative to the frame, such as for example a change in height.

An even further option, which may be applied to any embodiment of the wheel stand, one or more parts of the housing may be covered with a softer and/or higher friction covering material comparted to the material of the part of the housing that it is covering. For example, part of the housing may comprise a metal such as steel or a thermosetting polymer. The covering material may for example be or comprise felt or another textile material—which is typically softer than a metal or polymer—or the covering material may for example comprise a rubber or elastomer. The covering material may be used to protect the floor or surface on which the housing is positioned, and/or increase friction between the wheel stand and the floor or surface on which the wheel stand is positioned.

In particular, the covering material may be removably attached to the housing, for example using a magnetic connection. The covering material may be supplied on a magnetic substrate. When the covering material is attached using a magnetic connection, the covering material may be conveniently removed or replaced on the housing, preferably without leaving any trace on the housing. Especially when the housing can be positioned in different orientations when the wheel stand is not in use, it may be convenient to be able have removable covering material which the user can position on the appropriate side of the housing—i.e. the side facing of the housing facing down when the wheel stand is not in use.

A third aspect provides a race simulator assembly, comprising a wheel stand according to the first aspect or the second aspect, and a seat, such as a couch or chair, wherein the wheel stand is positioned adjacent to the seat. This positioning in particular allows a user sitting on the seat to position their feet into the housing of the wheel stand.

It will be understood that options disclosed in conjunction with the first aspect may be applied to the second aspect, and vice versa. It will further be understood that a wheel stand according to the first or second aspect may not be supplied with a chair, seat, or other sitting surface. This may allow the wheel stand to be more compact, and hence take up less space for example in the user's house, in particular the living room.

### BRIEF DESCRIPTION OF THE FIGURES

In the figures,

FIGS. 1A-C show an embodiment of a wheel stand in a perspective view;

FIG. 1D shows the wheel stand of FIG. 1A in an alternative orientation;

FIGS. 2A-B show an embodiment of a wheel stand in a side view;

FIG. 3A shows a perspective view of the wheel stand;

FIG. 3B shows detail A of FIG. 3A;

FIG. 4A shows a perspective view of the wheel stand;

FIG. 4B shows detail B of FIG. 4A;

FIG. 5 shows in a partially see-through side view an embodiment of a race simulator assembly; and

FIG. 6 shows the race simulator assembly of FIG. 5 with a user indicated.

### DETAILED DESCRIPTION

It will be understood that embodiments disclosed in the Figures are examples of one or more of the aspects disclosed herein. Options disclosed in conjunction with one of the Figures may be readily applied to other embodiments and aspects. For clarity and conciseness of the Figures, not each element has been provided with a reference numeral in each of the Figures. It will be understood that an absence of a reference numeral does not necessarily mean an absence of the element in the embodiment depicted in a particular Figure.

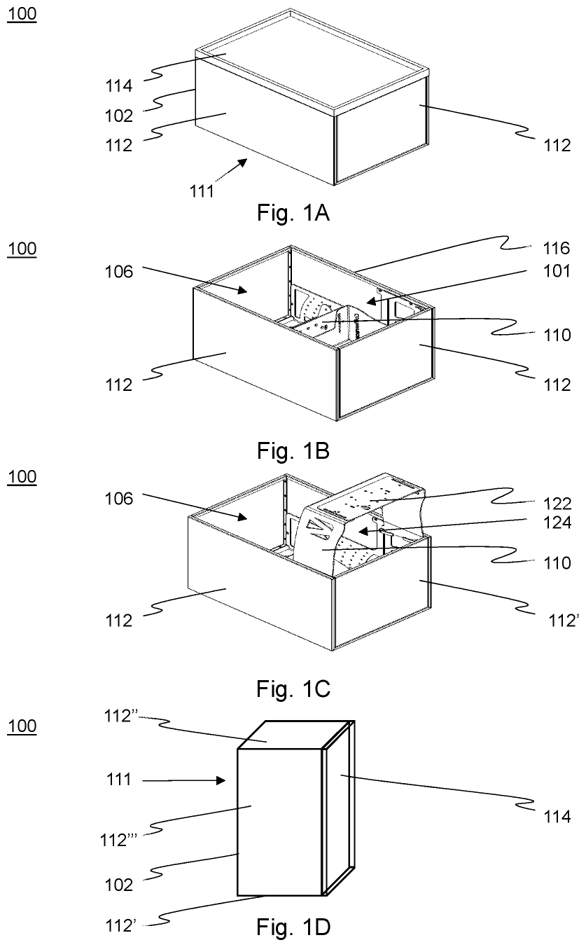

FIG. 1A shows an embodiment of a wheel stand 100 comprising a housing 102 and a lid 114 positioned on top of the housing 102. The wheel stand 100 further comprises a wheel mount, which is not visible in FIG. 1A because of the housing 102 and the lid 114 blocking view of the wheel mount. The lid 114 covers at least part of the top opening 106 of the housing 102, and preferably the lid 114 may cover the entire top opening 106 of the housing 102.

FIG. 1B shows the wheel stand 100 of FIG. 1A with the lid 114 removed, and the wheel mount 110 in a storage position. FIG. 1C shows the wheel stand 100 of FIG. 1B with the wheel mount 110 in a use position. In the use position, for example one or more game controllers such as a wheel, joystick, shifter, or any other controller may be mounted to the wheel mount 110 and used by a user. It will be understood that the game controller may remain mounted to the wheel mount 110 also when the wheel mount 110 is moved back to the storage position.

As for example shown in FIG. 1C, the wheel mount 110 may comprise a mounting plate 122—as an example of a mounting member—with a plurality of optional mounting holes, for mounting one or more controllers to. The mounting plate 122 may be positioned at a distal end of the wheel mount 110, wherein the distal end is defined relative to the housing 112 in the use position of the wheel mount 110. As shown in FIG. 1C, in the use position, the mounting plate 122 may be fully positioned outside the storage volume 101 of the housing 102.

The housing 102 depicted in FIGS. 1A-1C is substantially rectangular shaped, as a particular option. The housing 102 comprises a bottom 111 (not directly visible in the Figures), and a plurality of side walls 112. When the housing 102 is substantially rectangular shaped, the housing 102 comprises four side walls 112, and opposite side walls 112 are positioned substantially parallel to each other, while adjacent side walls 112 are positioned substantially perpendicular.

When the housing 102 is reoriented, one of the side walls 112 may face a floor or other supporting surface, instead of the bottom 111. In such an orientation, the bottom 111 may become visible to the user. The housing 102 may have a closed bottom 111 to prevent a user from looking into the storage volume 101 of the housing 102.

The side walls 112 may form an upper rim 116 of the housing 102, which upper rim 116 may form a perimeter of the top opening 106. The surface area of the top opening 106 may substantially correspond to the surface area of the bottom 111. As a further option, additionally or alternatively, in a top view, the top opening 106 and the bottom 111 may be substantially aligned. As an even further option, additionally or alternatively, the top opening 106 and the bottom 111 may be substantially parallel. The upper rim 116 may be arranged to support the lid 114.

As shown in FIGS. 1A-1C, the housing 102 may be positioned bottom down on a floor or other supporting surface. The outer shape of the housing 102, such as the housing 102 depicted in FIGS. 1A-1C, may allow the wheel stand 100 to be used as a piece of furniture, and for example the lid 114 may form a support surface or working surface on which one or more objects may be placed. The support surface is preferably flat.

One, more or all of the side walls 112 and/or the bottom 111 may be closed, to restrict or block view into the housing 102, in particular into the storage volume 101. As such, in particular when the wheel mount 100 is not in use, view on the wheel mount 110 may be obstructed. This may allow the wheel stand 100 to remain in sight—for example in a user's house or living room—without appearing to be a wheel stand 100.

In use, the housing 102 may be positioned near or adjacent to a couch, chair, or other seat. Such a seat may have a sitting height between 25-60 cm, in particular between 35-50 cm, more in particular between 40-45 cm. A height of the housing 102 may correspond to such a sitting height, may be lower than the sitting height or may be slightly higher than the sitting height. The height of the housing 102 may be defined by an offset distance between the bottom 111 and the upper rim 116, or by an offset distance between the bottom 111 and part of the housing 102 adjacent to the sitting height.

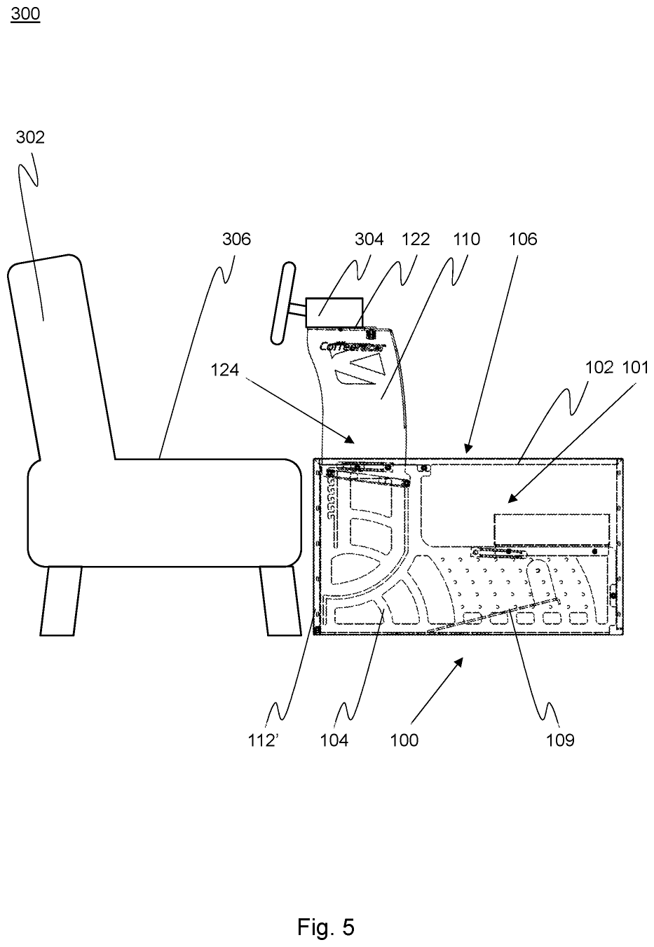

A user may position their feet and part of their legs into the housing 102, in particular into the storage volume 101. One of the side walls 112, for example side wall 112′ indicated in FIG. 1C and FIG. 5, may be at least partially removable, and/or may be provided with one or more openings or cut-outs to accommodate part of a user's legs. Side wall 112′ may be a side wall position approximately below the wheel mount 110, when the wheel mount 110 is in the use position. In use, the side wall 112′ may be closest to the seat or couch on which the user is sitting. The side wall 112′ may be the side wall 112 which is positioned approximately below the wheel mount 110 in the use position.

At least part of a bottom surface of the bottom 111 may be a high friction surface, to prevent or reduce the chance of a user pushing the housing 102 away. This may in particular occur when the user presses down and away on one or more pedals, for example when playing a racing simulation game. A high friction surface may be provided by virtue of a particular material, such as rubber, elastomer or another material with a high friction coefficient, and/or by a particular surface treatment.

Alternatively or additionally, the wheel stand 100 may comprise one or more weights, arranged for holding the wheel stand in place during use. The one or more weights may be removably attached to the housing 102.

FIG. 1A shows the wheel stand 100 in a first orientation, with the lid 114 positioned above the bottom 111. Another orientation is envisioned and depicted in FIG. 1D, wherein the bottom 111 is positioned substantially vertically, and one of the side walls 112 becomes the bottom in use. It will thus be understood that embodiments of the wheel stand 100 are envisioned which may be positioned in at least two orientations, for example corresponding to a “landscape” orientation, as shown in the FIGS. 1A-1C, and a “portrait” orientation, shown in FIG. 1D.

To prevent the lid 114 from falling off the housing 102 in other orientations, the lid 114 may be connected to the housing 102 for example using a clamped, magnetic, or other type of releasable connection. In particular, part of the lid 114 may be provided with a strip or surface comprising a magnetic material arranged to magnetically attach to the housing. The magnetic material may be covered with a soft material such as felt.

FIG. 1D shows the wheel stand 100 of FIG. 1A in an alternative orientation. The wheel stand 100 comprises the housing 102 and the lid 114 covering the top opening. Compared to the orientation of FIG. 1A, the wheel stand 100 may be regarded as being rotated 90 degrees relative to a horizontal rotation axis. The wheel mount is in the storage position, and is not visible in FIG. 1D.

The alternative orientation FIG. 1D may be allowed by virtue of two side walls 112′ and 112″ of the housing 102 being oriented substantially parallel. In the alternative orientation, the bottom 111 now is oriented at angle relative to the floor on which the wheel stand 100 is positioned, which angle in particular is approximately 90 degrees. Side wall 112′ now functions as bottom. Side wall 112″ may provide a useful surface, preferably substantially flat and horizontal, on which one or more objects may be placed.

To prevent the lid 114 from falling off or disconnecting from the housing in the alternative orientation, for example due to movement of the lid 114 and/or gravity, the lid 114 may be releasably connected to the housing 102. As a particular option, this connection may be a magnetic connection. Such a magnetic connection may not be visible from the outside, and may hence be visually preferred.

Although the bottom 111 may not visible to the user in the orientation shown in FIG. 1A, the bottom 111 may indeed become visible in the orientation of FIG. 1D. As such, it may be preferred that the bottom 111 has the same visual appearance as the side walls 112. The bottom 111 may be substantially closed—i.e. free of through-holes.

Although the wheel stand 100 is in FIG. 1D depicted with the lid 114, the lid 114 may be omitted for example when the top opening 106 faces a wall or is otherwise not visible. A side wall cover may be provided, which may be placed on top of the housing 102, in particular on side wall 112″. The side wall cover may for example be formed as a tray with a perimeter rim, similar to the lid 114 show in FIG. 1A. A width and depth of the side wall cover may substantially correspond to the side wall 112″. Objects may be placed on the side wall cover, instead of directly on the side wall 112″. The side wall cover may be of a different material than the side wall 112″, and may hence have a different appearance than the side wall 112″. A side wall cover may be arranged in particular for covering one of the small side walls of the housing.

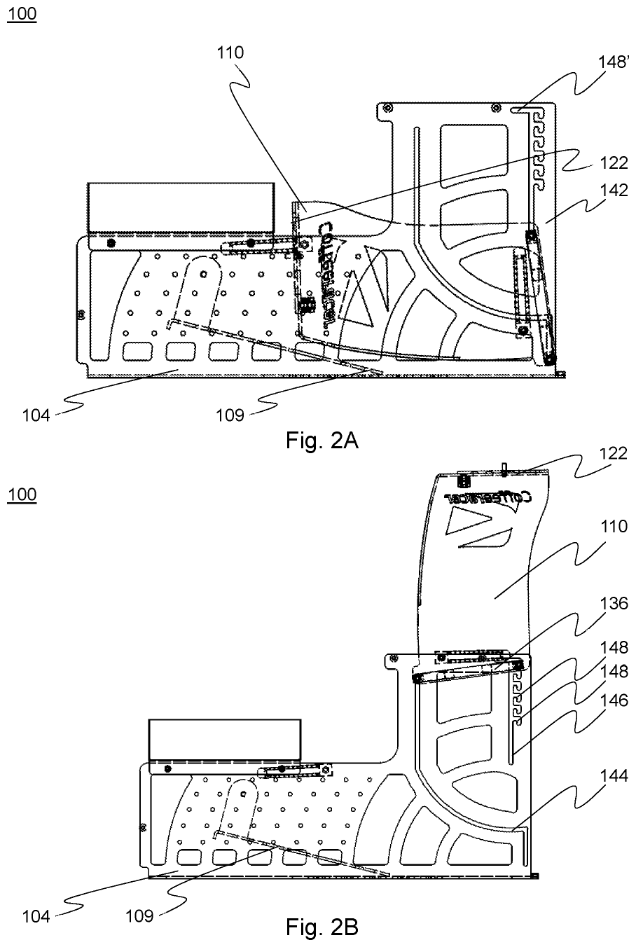

FIGS. 2A and 2B show a side view of an embodiment of wheel stand 100, respectively with the wheel mount 110 in a storage position and a use position. The frame 104 of wheel stand 100 is in FIGS. 2A-4B shown without a housing 102. However, embodiment of wheel stands 100 are envisioned based on the embodiments FIGS. 2A-4B which do comprise a housing 102, with the frame 104 positioned at least partially in said housing 102.

As can be seen in the example of FIGS. 2A and 2B, between the storage position and the use position, the orientation and position of the wheel mount 110 changes relative to the frame 104—respectively by virtue of a rotation and a translation of the wheel mount 110 and the frame 104.

The wheel mount 110 comprises a mounting plate 122, to which one or more controllers may be mounted. The mounting plate 122 may be substantially flat, but may in other examples also be at least partially curved.

As can be seen in the example of FIGS. 2A and 2B, between the storage position and the use position, the mounting plate 122 may both change orientation (e.g. between approximately vertical and approximately horizontal) and height (e.g. respectively between a lower and a higher position). Preferably, the height of the mounting plate 122 in the use position is changeable, in a plurality of discrete positions and/or within a particular height range. This allows the wheel stand 100 to be used by differently sized users and/or with different seat height and/or with differently sized controllers such as racing wheels.

As for example shown in FIG. 2A, the wheel stand 100 may also comprise a pedal stand 109. One or more pedals may be mounted to or positioned onto the pedal stand 109. A position and/or orientation of the pedal stand 109 may be adjustable relative to the housing 102, to accommodate differently sized users and/or differently sized pedals. The pedal stand 109 may be mounted directly to the housing 102, or may be mounted to the frame 104. The pedal stand may be mounted parallel to the floor or at an inclination.

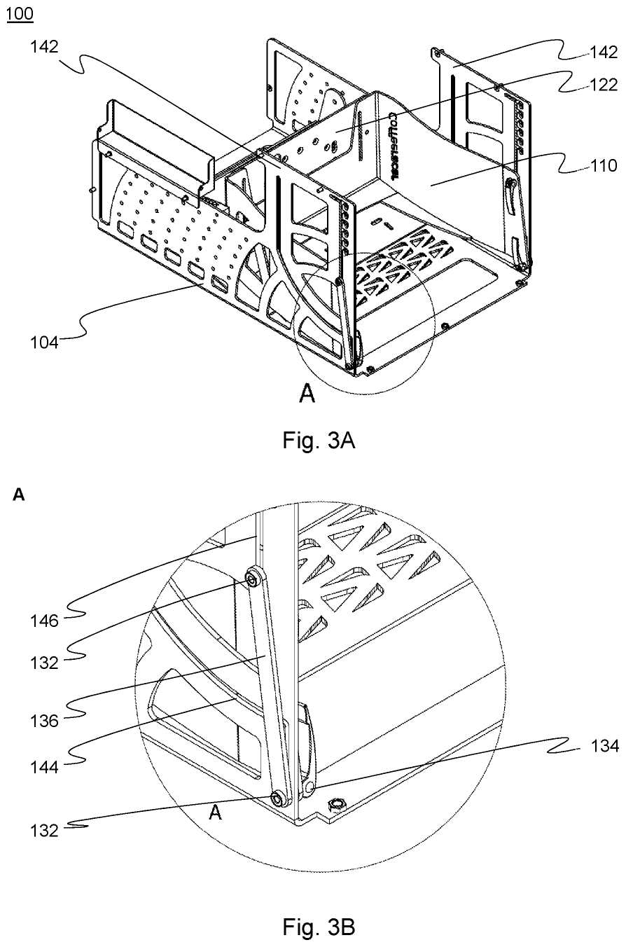

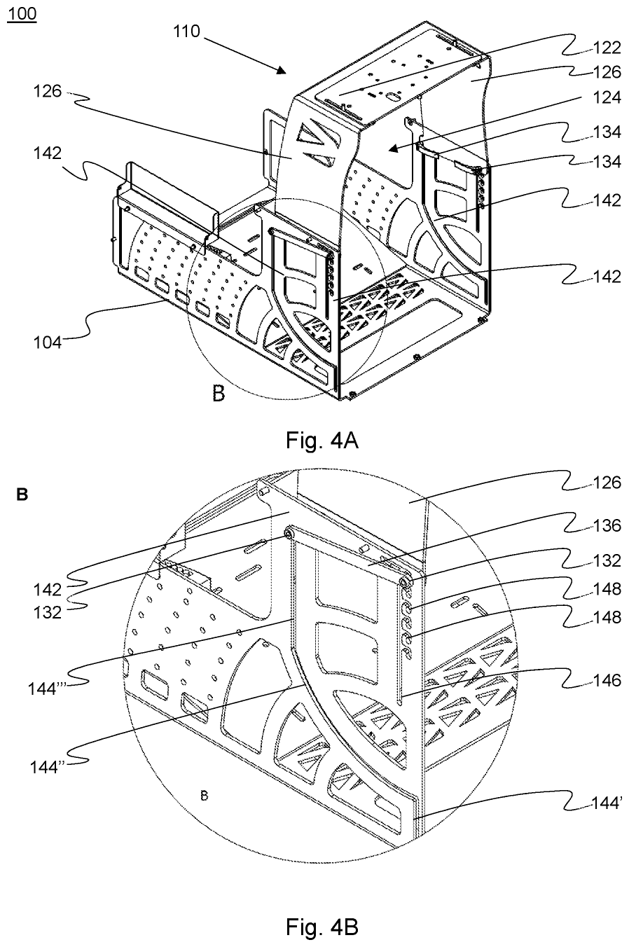

FIG. 3A shows a perspective view of a frame 104 of a wheel stand 100, and FIG. 3B shows detail A. In FIGS. 3A and 3B, the wheel mount 110 is shown in the storage position-corresponding to FIG. 2A. FIG. 4A shows another perspective view of the frame 104 of the wheel stand 100, and FIG. 4B shows detail B. In FIGS. 4A and 4B, the wheel mount 110 is shown in the use position-corresponding to FIG. 2B.

As can be seen in FIGS. 3A and 4A, the embodiment of the frame 104 comprises two guide plates 142 as an example of two frame guides, which are as an option positioned on opposite sides of the frame 104. The wheel mount 110, and in particular the mounting plate 122, is positioned in-between the two guide plates 142. It will be understood that alternatively shaped frame guides other than the guide plates may be used.

Both guide plates 142 comprise a rear guide 144 and a front guide 146, which are embodied as slots through the guide plates 142. The rear guide 144 and the front guide 146 are indicated in FIGS. 3B and 4B, respectively showing detail A and detail B.

The mounting plate 122 may be formed by the wheel mount 110, or may be moveably connected to the wheel mount 110. Movement of the mounting plate 122 relative to the wheel mount 110 may allow repositioning of the mounting plate 122—and thus a controller mounted to mounting plate 122—to accommodate a particular user's size and preference.

For example in the embodiment shown in FIGS. 3A-4B, the wheel mount 110 comprises two carrying plates 126 as an example of two carrying members, which together with the mounting plate 122 form a generally U-shaped wheel mount 110. Each carrying plate 126 is moveably connected to one of the guide plates 142.

Guiding members 132, each for example embodied by or comprising a pin, are used to connect the wheel mount 110 to the frame 104—in particular to connect the carrying plates 126 to the guide plates 142. When the wheel mount 110 is moved between the storage position and the use position, the guiding members 132 pass through their respective guide (i.e. one of the front guide 146 and the rear guide 144).

The front guide 146 is provided with a plurality of resting positions 148, which resting positions 148 are positioned at different heights relative to the frame 104. A guiding member 132 can be positioned in the resting position 148, and in the resting position, movement of the guiding member 132 in particular directions is restricted, such as in a downward, forward and rear direction. When the wheel mount 110 is in the use position, two guiding members 132 associated with the front guide 146 may be aligned in a resting position 148 of their associated front guide 146. A resting position 148 may be formed by a generally L-shaped part of a guide.

A particular resting position 148′ is indicated in FIG. 2A, and may be used as a temporary position, which allows a user to more conveniently position part of their legs into the housing, in particular through opening 124.

As can be seen for example in FIG. 4B, the rear guide 144 may be formed by a plurality of adjacent guide sections. In this particular example, the rear guide 144 comprises a substantially straight lower guide section 144′, a curved middle guide section 144″, and a substantially straight upper guide section 144″.

The substantially straight lower guide section 144′ may be used to restrict movement between the wheel mount 110 and the frame 104 when the wheel mount 110 is in the storage position, for example shown in FIG. 3B. The substantially straight upper guide section 144′″ may allow for adjusting the height of the wheel mount 110 in the use position.

The curved middle guide section 144″ may have a substantially constant radius relative to a point in the front guide 146. The constant radius may correspond to a fixed distance between two guiding members 132 on the same carrying plate 126. By moving through the curved middle guide section 144″, the orientation of the wheel mount 110 relative to the frame 104 may be changed. For example, in use with the bottom 111 down, by passing through the curved middle guide section 144″, the mounting plate 122 is moved from a substantially vertical orientation to a substantially horizontal use position.

One, more, or all guiding members 132 may be provided with a clamp, for example an eccentric clamp 134, for fixating the position of that guiding member 132 relative to their respective guide plate 142. Two guiding members 132 associated with one of the guide plates 142 may be connected via a connection member 136. The connection member 136 may be positioned on the outsides of the frame 104—i.e. on the other sides of the guide plates 142 than the carrying plates 126.

FIG. 5 shows in a partially see-through side view an embodiment of a race simulator assembly 300. The assembly 300 comprises an example of a wheel stand 100, comprising a wheel mount 110 with a mounting plate 122 as an example of a mounting member. A racing wheel controller 304 is mounted to the mounting plate 122. As an option, one or more pedals may be positioned inside the housing 102, to together with the racing wheel controller 304 allow a user to control a race simulator game.

The assembly 300 further comprises a couch 302 as an example of a seat. The couch 302 provides sitting surface 306 at a particular seat height, for a user to sit down.

In the assembly 300, the wheel stand 100 is positioned adjacent to the couch 302, such to allow a user sitting on the sitting surface 306 to position their feet into the housing 102 of the wheel stand 100. As an option, part of the legs of the user may pass through an opening 124 of the wheel mount 110, and part of the legs of the user may in use be positioned inside the housing 102. When a wheel stand 100 comprises two guide plates 142, the legs of the user may in use be positioned in-between the two guide plates 142.

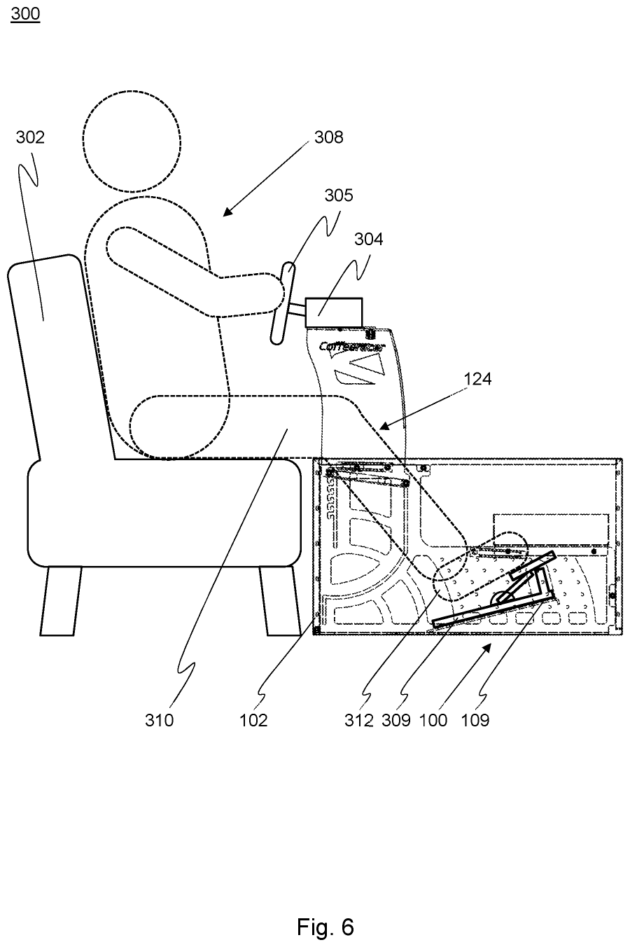

FIG. 6 shows the race simulator assembly 300 of FIG. 5, with a user 308 indicated with dashed lines, to further elaborate on the position of the user's body in the race simulator assembly 300, in particular with respect to the wheel stand 100. As can be seen in FIG. 6, legs 310 of the user 308 may be positioned partially into the housing 102, in particular through the opening 124. A foot 312 of the user 308 is shown resting on a pedal 309 inside the housing 102, which pedal 309 may be positioned on pedal stand 109. The pedal 309 may for example be used as a controller for braking, a clutch, or throttle.

As can be seen in FIG. 6, part of the housing 102—in particular part of the storage volume 101—may remain empty during use. In the side view FIG. 6, this part is the right upper corner of the housing 102. The empty part may be a result of the rectangular shape of the housing 102. Although a rectangular shaped housing may hence not be the most optimal shape in terms of used storage volume, the rectangular shape may provide for other functionalities of the wheel stand, when the wheel stand is not in use.

Also depicted in FIG. 6 is the option that part of the racing wheel controller 304, in particular a steering wheel 305 or yoke, extends beyond the housing 102 in a top plan view or side view. The steering wheel 305 may be regarded as being positioned above the chair 302.

In the description above, it will be understood that when an element is referred to as being connect to another element, such as a frame connected to a housing or a wheel mount connected to a frame, the element is either directly connected to the other element, or intervening elements may also be present. Also, it will be understood that the values given in the description above, are given by way of example and that other values may be possible and/or may be strived for.

It is to be noted that the Figures are only schematic representations of embodiments that are given by way of non-limiting examples. For the purpose of clarity and a concise description, features are described herein as part of the same or separate embodiments, however, it will be appreciated that the scope of the disclosure may include embodiments having combinations of all or some of the features described.

The word ‘comprising’ does not exclude the presence of other features. Furthermore, the words ‘a’ and ‘an’ shall not be construed as limited to ‘only one’, but instead are used to mean ‘at least one’, and do not exclude a plurality.

1. A wheel stand, comprising:
a housing with a storage volume therein and a top opening allowing access into the storage volume;
a wheel mount moveably attached to the housing, such that the wheel mount can be moved relative to the housing between a storage position and a use position, wherein:
in the storage position, the wheel mount is positioned inside the storage volume of the housing; and
in the use position, the wheel mount is at least partially positioned outside the storage volume of the housing.

2. The wheel stand according to claim 1, further comprising a lid for covering the top opening.

3. The wheel stand according to claim 1, wherein the wheel mount is arranged to at least partially pass through the top opening when moved between the storage position and the use position.

4. (canceled)

5. The wheel stand according to claim 1, wherein the housing comprises a bottom and a plurality of side walls extending substantially perpendicular to the bottom.

6. The wheel stand according to claim 1, wherein the housing comprises more than two side walls, and wherein two of the side walls are oriented parallel, which two side walls are smaller than at least one other side wall adjacent to one of the two parallel side walls.

7. The wheel stand according to claim 1, wherein the housing is rectangular shaped.

8. The wheel stand according to claim 1, wherein the housing is closed, apart from the top opening.

9. The wheel stand according to claim 8, wherein the housing is closed, apart from the top opening, when the wheel mount is in the use position.

10. The wheel stand according to claim 1, wherein the wheel mount comprises a mounting member at a distal end of the wheel mount for mounting a racing wheel controller to, and wherein in the use position of the wheel mount, the mounting member is positioned outside the housing.

11. The wheel stand according to claim 1, further comprising a frame, wherein:
the frame is positioned in the storage volume of the housing; and
the wheel mount is moveably connected to the frame, such that the wheel mount can be moved relative to the frame between the storage position and the use position.

12. The wheel stand according to claim 11, wherein the frame comprises two frame guides at opposite sides of the frame, and wherein the wheel mount is at least partially positioned between the frame guides.

13. The wheel stand according to claim 12, wherein the mounting member is positioned between two carrying members comprised by the wheel mount, and wherein each carrying member is moveably connected to a respective one of the frame guides.

14. The wheel stand according to claim 12, wherein:
the frame guides both comprise a rear guide and a front guide;
the wheel mount comprises four guiding members, each coupled to one of the rear guide and the front guide of one of the frame guides; and
when moving the wheel mount relative to the frame, the guiding members are guided through their respective one of the rear guide and the front guide.

15. The wheel stand according to claim 14, wherein one of the rear guide and the front guide comprises two adjacent guide sections, of which a first guide section is a curved guide section, and a second guide section is a straight guide section.

16-17. (canceled)

18. The wheel stand according to claim 10, further comprising a racing wheel controller mounted to the mounting member wherein the racing wheel controller in a top plan view at least partially extends beyond the housing.

19. (canceled)

20. The wheel stand according to claim 5, wherein in the use position, one of the side walls of the housing is positioned below the wheel mount.

21. The wheel stand according to claim 5, further comprising a side wall cover arranged to cover one of the side walls.

22. (canceled)

23. The wheel stand according to claim 1, with the proviso that the wheel stand does not comprise a chair or seat.

24-25. (canceled)

26. The wheel stand according to claim 1, wherein the wheel stand is arranged to be positioned in a first orientation, and a second orientation being rotated 90 degrees relative to the first orientation relative to a horizontal rotation axis.

27. A race simulator assembly, comprising:
a wheel stand according to claim 1; and
a seat, such as a couch or chair,
wherein the wheel stand is positioned adjacent to the seat to allow a user sitting on the seat to position their feet into the housing of the wheel stand.
